(19) United States
(12) Patent Application Publication
(10) Pub. No.: US 2018/0191635 A1
(43) Pub. Date: Jul. 5, 2018

(54) COMMUNICATIONS NETWORK

(71) Applicant: BRITISH TELECOMMUNICATIONS PUBLIC LIMITED COMPANY, London (GB)

(72) Inventors: Vidhyalakshmi KARTHIKEYAN, London (GB); Detlef NAUCK, London (GB)

(21) Appl. No.: 15/740,520

(22) PCT Filed: Jun. 30, 2016
(86) PCT No.: PCT/EP2016/065434

§ 371 Date: Dec. 28, 2017

(30) Foreign Application Priority Data
Jun. 30, 2015 (EP) 15275166.5
Sep. 28, 2015 (EP) 15187163.9
Sep. 30, 2015 (EP) 15187813.9

(51) Int. Cl. H04L 12/927; H04L 12/725

(52) U.S. Cl. CPC H04L 47/805; H04L 45/302

(57) ABSTRACT

The present invention provides a method of operating a communications network such that routing models for the network can be constructed on the basis of parameters which are not directly related to the transmission performance of the network. Indirectly related parameters, such as resilience, cost or energy use, may be used to construct the routing models such that a request for a communication session may be based on a required indirect parameter value.

### FIELD OF THE INVENTION

The present invention relates to methods of operating communications networks and in particular to the operation of networks whilst ensuring that quality of service provision is maintained.

### BACKGROUND TO THE INVENTION

There are two main ways for network operators to provide granular performance guarantees: Integrated Services (IntServ) and Differentiated Services (DiffServ). Whilst IntServ has suffered from scalability challenges, DiffServ has become popular. Within the DiffServ framework, operators choose to provide various Classes of Service (CoS) such as Expedited Forwarding (EF), Assured Forwarding (AF) and Best Effort (DE) delivery, each of which corresponds to different Quality of Service (QoS) promises. For example, an operator can choose to offer within a single country 20 ms of round trip delay, 99.9% packet delivery rate and a jitter of 2 ms for a CoS like EF. Consumers, i.e. service providers that deliver data over the networks, purchase a specified throughput through the network in advance with pre-defined characteristics for which they expect pre-agreed Service Level Agreements (SLAs). Performance is monitored on the network and should performance drop below the promised targets, the network operator might have to compensate for this breach using a credit system or similar. The data packets that enter the network from the client (either a single client or a group of clients) are marked with the appropriate CoS in the traffic in the Type of Service (ToS) field or in the Differentiated Services Code Point (DSCP) field by the client themselves or an edge device managed by the operator.

The applicant's co-pending international patent application WO2014/068268 discloses a method in services are re-mapped to a different class of service based on predictive analytics on network performance for all the available classes of service. However, this proposal still adhered to the 5 major classes of services (EF, AF1, AF2, AF3, DE) for re-mapping. In the ensuing discussion the conventional EF/AFx/DE DiffServ model will be referred to as classic DiffServ to distinguish its behaviour from the adaptive QoS model of WO2014/068268.

There are two main ways for network operators to provide granular performance guarantees: Integrated Services (IntServ) and Differentiated Services (DiffServ). Whilst IntServ has suffered from scalability challenges, DiffServ has become popular. Within the DiffServ framework, operators choose to provide various Classes of Service (CoS) such as Expedited Forwarding (EF), Assured Forwarding (AF) and Best Effort (DE) delivery, each of which corresponds to different Quality of Service (QoS) promises. For example, an operator can choose to offer within a single country 20 ms of round trip delay, 99.9% packet delivery rate and a jitter of 2 ms for a CoS like EF. Consumers, i.e. service providers that deliver data over the networks, purchase a specified throughput through the network in advance with pre-defined characteristics for which they expect pre-agreed Service Level Agreements (SLAs). Performance is monitored on the network and should performance drop below the promised targets, the network operator might have to compensate for this breach using a credit system or similar. The data packets that enter the network from the client (either a single client or a group of clients) are marked with the appropriate CoS in the traffic in the Type of Service (ToS) field or in the Differentiated Services Code Point (DSCP) field by the client themselves or an edge device managed by the operator.

The applicant's co-pending international patent application WO2014/068268 discloses a method in services are re-mapped to a different class of service based on predictive analytics on network performance for all the available classes of service. However, this proposal still adhered to the 5 major classes of services (EF, AF1, AF2, AF3, DE) for re-mapping. In the ensuing discussion the conventional EF/AFx/DE DiffServ model will be referred to as classic DiffServ to distinguish its behaviour from an adaptive QoS model, such as that disclosed by WO2014/068268.

### SUMMARY OF THE INVENTION

According to a first aspect of the invention, there is provided a method of operating a communications network, the method comprising the steps of: defining a plurality of parameter value bins for one or more parameters which are indirectly linked to the performance of the network, for each of a plurality of routes through a communications network; determining an average value for the one or more indirect parameters for the route and assigning the route to one of the plurality of parameter value bins; and determining a measure of the variance of the indirect parameter from the centre of the assigned parameter value bin; receiving a request for a communications session through the communications network, the request comprising a request for the session to be assigned to a route assigned to one or more of the plurality of parameter value bins; and

accepting the request for the communications session if such a request can be satisfied. The assignment of each of the plurality of network routes to one of the plurality of parameter value bins may comprise a cluster analysis of the plurality of indirect parameter values.

According to a second aspect of the present invention there is provided a data carrier device comprising computer executable code for performing a method as described above.

According to a third aspect of the present invention there is provided an apparatus configured to, in use, perform a method as described above.

According to a fourth aspect of the present invention there is provided a communications network comprising a plurality of nodes, a plurality of communications links inter-connecting the plurality of nodes, and a network gateway, the communications network being configured to, in use, perform a method as described above.

### BRIEF DESCRIPTION OF THE FIGURES

In order that the present invention may be better understood, embodiments thereof will now be described, by way of example only, with reference to the accompanying drawings in which:

FIG. 1 shows a schematic depiction of a communications network 100 according to an embodiment of the present invention.

### DETAILED DESCRIPTION OF EMBODIMENTS

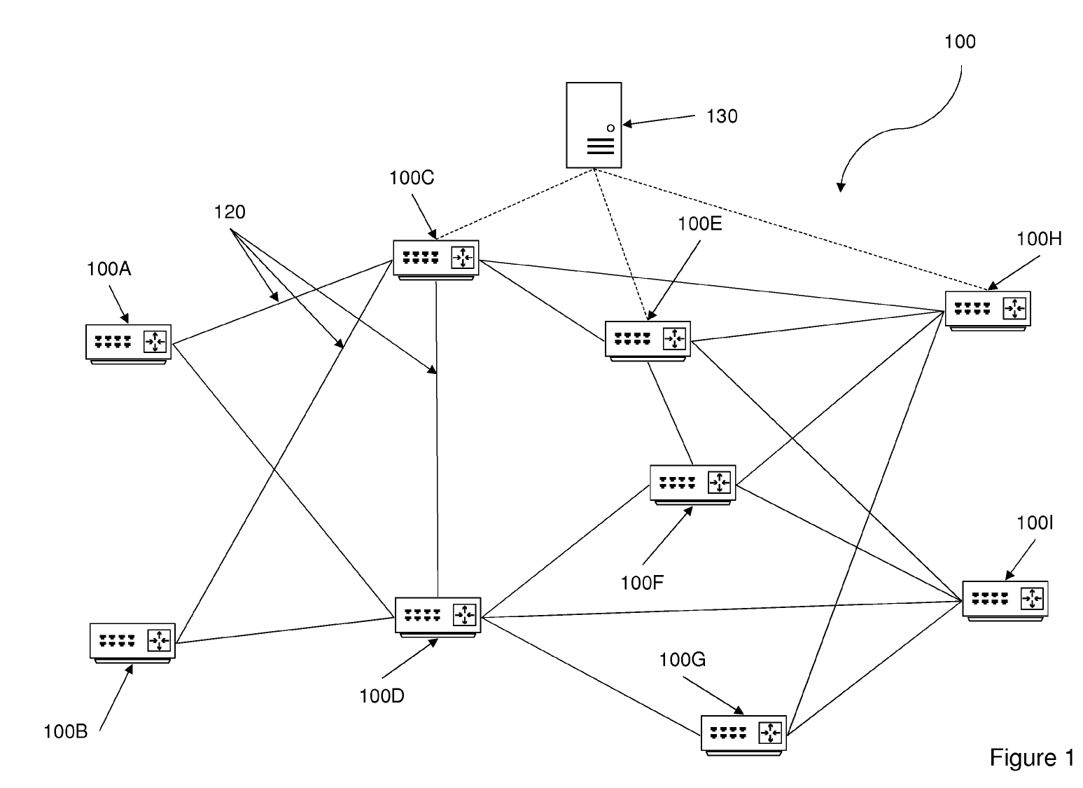

FIG. 1 shows a schematic depiction of a communications network 100 according to an embodiment of the present invention. The communications network 100 comprises a plurality of routers 100A, 1008, 100C, . . . , 100I. Communications links 120 provide interconnections between a first router and a second router. It will be understood that each of the plurality of routers are not connected to all of the other routers which comprise the network. FIG. 1 shows that routers 100A and 100B form a first edge of the network, Similarly, routers 100H and 100I form a second edge of the network. These routers may be referred to as edge routers. Requests to establish a session through the network, such that data might be transmitted across the network, may be received at the edge routers at the first edge or the second edge of the network. The routers 100C, 100D, 100E, 100F & 100G will receive data which has originated from a first edge router and which is destined to the be routed to a second edge router. These routers may be referred to as core routers. The network further comprises a network gateway 130 which manages the performance of the routers and accepts, or rejects, requests to admit sessions to the network. More specifically, the network gateway learns performance models from historic traffic data carried over the communications network, assigns performance models to routes through the network and monitors and manages performance models throughout their life cycle.

In one example, a performance model may comprise a three-dimensional performance-based model comprising of jitter J, loss L and delay D. Each performance model Pᵢ can be characterised by a prototype vector

pᵢ=(j̅ᵢ,l̅ᵢ,d̅ᵢ) [1]

and a 99% confidence interval vector

cᵢ=(cjᵢ,clᵢ,cdᵢ) [2]

The prototype vector pᵢ specifies the typical or average performance of the parameters which comprise the model and the confidence vector cᵢ specifies the 99% confidence interval p±c for each component p of pᵢ (it will be understood that other confidence intervals or other determinations of parameter variability may be used). The advantage of this representation over an interval based representation is that we can easily determine the distance of the current performance of a transmission to any performance model. We can also evaluate the consistency or value of a performance model, i.e. smaller confidence intervals indicate that we will see less deviation from the desired performance.

Instead of a confidence interval, we can also use a quantile, e.g. the 99% percentile. This will indicate that 99% of the measured performance values will be within a certain threshold, i.e. p<c for 99% of all values. This may be sufficient for a client who wants to know what the worst case performance of the transmission could be, but it is less useful for an operator who may want to define performance intervals that are clearly separated from each other.

Instead of directly exposing the vector cᵢ to clients the operator can also choose to use a different type of interval or threshold around the prototype, for example a deviation of less than x % per component and publish that to clients. The confidence vector is then only used internally by the network in order to decide if a prototype is stable enough to constitute a performance model.

Performance models may be identified by means of cluster analysis applied to transmission performance data which has been obtained from the end to end traffic that has been admitted into the network. Each transmission Tₖ may be represented by a vector tₖ=(jₖ,lₖ,dₖ) specifying, for example, the average jitter, loss and delay parameter values observed over the period of the transmission (it will be understood that the traffic performance may be characterised using other metrics in addition to, or as an alternative to, jitter, loss and delay). Cluster analysis will discover the natural groupings in the traffic and learn a number of model prototype vectors pᵢ. The 99% confidence interval p±c for a component p of a prototype vector p is computed by

$$c = \frac{2.58}{\sqrt{n}} s \qquad [ 3 ]$$

where s is the standard deviation of the sample used to compute the prototype component and n is the sample size. We assume that a prototype vector is the component-wise arithmetical mean of all sample vectors assigned to a cluster by the clustering algorithm, which is the case for centroid-based clustering algorithms using the Euclidean distance.

The computation of the 99% confidence interval for each component uses the fact that sample means are normally distributed and that the standard deviation of their distribution can be estimated by dividing the standard distribution of the data sample by \sqrt{n} (where n is the sample size). For a normal distribution 99% of the data is covered by an interval extending 2.58 times to either side of the mean. We are using the 99% confidence interval of the sample mean as an estimate for the reliability of a performance model. The network operator can set thresholds in relation to the model prototypes which represent the average performance of a data transmission according to a model. For example, if a component of a confidence vector is larger than 10% of the equivalent component of a model prototype vector, the model can be deemed unreliable because the expected variation of from the mean is considered to be too large.

In addition to identifying prototypes through cluster analysis it is also possible to define pre-determined prototype models which represent default QoS models that the network operator wishes to offer to its clients. For these prototypes, it is only necessary to compute confidence vectors and these vectors are not then changed using cluster analysis.

Once the performance models have been identified through clustering or by pre-determination, we label each entry in the training database with the closest performance model (or a number of closest performance models in the case when using a fuzzy clustering approach). In the next step we identify which routes through the network are associated with which performance model and how close the traffic on each route matches the associated performance models. By using the labelled entries in the training database we assign a list of performance models to each route R by using the following criteria for each performance model Pᵢ.
1) Sufficient Evidence: Were there at least tₘᵢₙ>0 transmissions on R that have been mapped to Pᵢ? (this threshold tₘᵢₙ is set by the network operator)
2) Sufficient Quality: Is the confidence vector cᵢ computed from the transmissions on R mapped to Pᵢ good enough, i.e. are the components of cᵢ smaller than a threshold specified by the network operator?

After this assignment has been completed, we have obtained a list of performance models and their qualities for each route through the network. It is possible that there will be routes with no assigned performance models. This can happen because there is not enough traffic on a route and therefore insufficient evidence to be able to assign a model to the route. It is also possible that the traffic on a route is so diverse that it does not match any performance model sufficiently closely so any model mapped to the route would not provide adequate quality. The network operator would not be able to make any QoS guarantees for such routes determined in this manner. The QoS guarantees for such routes could follow conventional approaches such as classic DiffServ QoS models. Alternatively, the operator could decide to compute a bespoke model P_{R} that represents the average QoS conditions on this route R and offer guarantees according to the confidence vector c_{R} for this model. In this case p_{R} would not be obtained through clustering but simply by averaging the vectors tₖ^{(R)} for the transmissions on R.

After performance models have been assigned to routes through the network, the available bandwidth for each route and each performance model can then be determined. This can be done by computing the amount of traffic that has been carried over each route in the past and how it was distributed over each of the assigned models. Alternatively, the network may maintain a single capacity per route and manage capacity across models instead of per model.

The network gateway 130 re-runs this algorithm in regular intervals set by the network operator, e.g. every hour. In between the re-runs the network gateway collects traffic data and adds it to the training database. Old entries in the training database are removed (or alternatively marked as being invalid and then removed after a period of remaining invalid) after a period of time to make sure that the algorithm does not use outdated information. After each re-run the network gateway compares the new performance models to the current performance models and updates the model database. If a new model is very similar to a previous model the network gateway may decide to retain the old model instead. The similarity is based on the Euclidean distance between the model prototype vectors and the operator will set a threshold for an acceptable distance for which two prototype vectors would be considered similar enough to represent the same model. This procedure avoids rapid changes in advertised models if the performance differences would not be significant.

The network gateway stores all models in a model database M and in a Model-Route mapping Table MR. The model gateway also collects and updates statistics for all models and routes by monitoring all traffic that traverses the network mapped to any performance model in regular intervals as defined by the operator, for example every 10 minutes. All traffic flows are counted for each performance model and capacity is then calculated for each model. This is done for each model overall in M and per model and route in MR. The values in MR are used for the decision if a flow can be admitted on a route R using a particular performance model. The bandwidth available to a model on a particular route and the confidence vector of a model will be regularly updated based on traffic monitoring and predictive values can be computed based on historic data and a predictive model, for example, linear regression or a neural network (M Berthold & D J Hand, “Intelligent Data Analysis”, Springer, Berlin, 1999).

The training data table T contains entries representing the QoS of all end-to-end data transmissions within a given time period. The operator configures for how long historic traffic flows remain in T and the duration should reflect an expected period of stability for the network where the operator does not expect routes or traffic patterns to change substantially. If the operator wishes to build a time-dependent predictive model for the reliability and capacity of models then the duration should reflect this, for example 24 hours or 1 week. The following discussion assumes a duration of 24 hours.

A traffic flow is entered into T as soon as it enters the network. The statistics of a flow are updated when the flow ends or on a periodic basis, for example every 20 minutes. Flows that last longer than the update period will be entered into the training table T again such that T contains a representation of all statistical features of a flow over time. Rows 1 and 4 in Table 1 below illustrate this. A flow on route 1 started at time 13.00 and completed at time 13.38 leads to the creation of two rows of statistics in T. If a flow has entered the network using a particular performance model this is also recorded in T.

TABLE 1
Extract from the training data table T at 14:00 on Mar. 20, 2015

| | | | | Throughput | Jitter | Loss | Delay | |
|---|---|---|---|---|---|---|---|---|
| ID | Route | tₛ | tₑ | (Mbps) | (ms) | (%) | (ms) | Model |
| 1 | 1 | 13.00 | 13.20 | 9.88 | 3.053416 | 0.148704 | 24.72323 | 1 |
| 2 | 2 | 13.05 | 13.15 | 10.18 | 3.030675 | 0.150843 | 25.04373 | 1 |
| 3 | 3 | 13.00 | 13.20 | 9.81 | 2.955859 | 0.15138 | 24.61943 | 1 |
| 4 | 1 | 13.20 | 13.38 | 9.84 | 2.989925 | 0.151806 | 24.64379 | 1 |
| . . . | . . . | . . . | . . . | . . . | . . . | . . . | . . . | . . . |

The model database M contains an entry for each model that has been discovered by the learning algorithm. The network gateway uses the model database M to decide how long a model will be kept active for and whether new models should be accepted into M. The network gateway records all global statistics for each model in M, i.e. statistics across the whole network. The confidence vector and the number of flows (cluster support) indicate how reliable and how well supported by traffic a model is, respectively. When a new model has been identified it is compared against all entries in M and if the distance to any prototype is smaller than the operator defined threshold the new model is discarded.

The number of traffic flows that were assigned to the model and their accumulated bandwidth can be used as indicators when a model is no longer used and should be retired. In the same manner the confidence vector can be used to decide if the reliability of a model is no longer sufficient and that it should be removed.

TABLE 2
Extract from the Model Database M at 14:00 on Mar. 20, 2015

| | | | | | Global Statistics | | | | |
|---|---|---|---|---|---|---|---|---|---|
| | | | | | | | Peak | | |
| Base Data | | | | Capacity | | Peak | Demand | 1 hr | |
| ID | Prototype | Confidence | Created | [Mb/s] | Routes | Flows | [Mb/s] | Flows | . . . |
| 1 | (3.1, | (0.0280, | Mar. 20, 2015 | 200 | 3 | 24 | 153 | 13 | . . . |
| | 0.1521, | 0.0015, | 12:00 | | | | | | |
| | 25.15) | 0.2193) | | | | | | | |
| 2 | (4.00, | (0.0395, | Mar. 20, 2015 | 150 | 3 | 0 | 0 | 0 | . . . |
| | 0.1003, | 0.0008, | 14:00 | | | | | | |
| | 29.76) | 0.2235) | | | | | | | |
| 3 | (2.50, | (0.0211, | Mar. 20, 2015 | 300 | 3 | 0 | 0 | 0 | . . . |
| | 0.1995, | 0.0017, | 14:00 | | | | | | |
| | 19.90) | 0.1905) | | | | | | | |
| . . . | . . . | . . . | . . . | | . . . | . . . | . . . | . . . | . . . |

The model-route mapping table MR lists all routes with all models assigned to them. The statistics in the model-route mapping table are the same as those in the model database, but they are computed on a per route basis. The model-route mapping table MR is used by the network gateway to decide which model can be offered on which route. A model that is not sufficiently reliable or which is not used regularly can be removed from the model-route mapping table. New models are inserted into the model-route mapping table once they have been inserted into the model database. Similarly, a model will be removed from the model-route mapping table when it is removed from the model database.

TABLE 3
Model-Route Mapping Table MR at 14:00 on Mar. 20, 2015

| | | | | | Route-based Statistics | | |
|---|---|---|---|---|---|---|---|
| Base Data | | | | | | Peak | |
| | Model | Route | Active | Capacity | Peak | Demand | |
| Route | ID | Confidence | since | [Mb/s] | Flows | [Mb/s] | . . . |
| 1 | 1 | (0.0280, | Mar. 20, 2015 | 100 | 8 | 82 | |
| | | 0.0015, | 12:00 | | | | |
| | | 0.2193) | | | | | |
| 2 | 1 | (0.0280, | Mar. 20, 2015 | 50 | 9 | 48 | |
| | | 0.0015, | 12:00 | | | | |
| | | 0.2193) | | | | | |
| 3 | 1 | (0.0280, | Mar. 20, 2015 | 50 | 7 | 23 | |
| | | 0.0015, | 12:00 | | | | |
| | | 0.2193) | | | | | |
| 4 | 2 | (0.0395, | Mar. 20, 2015 | 200 | 0 | 0 | . . . |
| | | 0.0008, | 14:00 | | | | |
| | | 0.2235) | | | | | |
| . . . | . . . | . . . | . . . | | . . . | . . . | . . . |
| 9 | 3 | (0.0211, | Mar. 20, 2015 | 100 | 0 | 0 | . . . |
| | | 0.0017, | 14:00 | | | | |
| | | 0.1905) | | | | | |
| . . . | . . . | . . . | . . . | | . . . | . . . | . . . |

The network performance data can be analysed to determine one or more cluster centres. These can then be used as the basis for the QoS SLAs that are offered over the network. For example, if the cluster centre denotes a traffic SLA of {delay, jitter, loss}=(20 ms, 2 ms, 0.1%) with 4 routes having a performance profile that can support this for time T into the future, this SLA is advertised with a specific DSCP or ToS codepoint which can be used by traffic flows that wish to be delivered with this SLA. The repository of such advertisements can be held at a known location such as an edge router, a session admission unit, a bandwidth broker or at a network interface between a client site and the network itself.

A client will determine the closest match to their required SLA from one of the advertised QoS SLAs at a particular time and mark their packets in the IP layer according to the behaviour they would like from the network. This involves computing the similarity of a requested QoS against an offered QoS, which can either be done by the client or by a translation device, for example the network gateway or another device managed by the network, aware of the client's QoS requirements on a per application or service type basis. Alternatively, acceptable boundaries of QoS can be pre-determined by the service provider on a service by service basis in by specifying a set of performance parameters for each application type, for example in the form of: application type, (minimum throughput required, lower jitter boundary, upper jitter boundary, lower delay boundary, upper delay boundary, lower RTT boundary, upper RTT boundary). Alternatively, this information could be represented as a percentage tolerance from the ideal QoS requirements. If such strict boundaries are not pre-defined, the network interface to the client may use a similarity function to determine the most appropriate QoS required for the specific service request.

It will also be noted that the learning algorithm uses both automatic cluster centre discovery as well as clustering around fixed cluster centres. The fixed cluster centres could correspond to conventional EF/AFx/DE QoS SLAs in order to provide backwards compatibility with clients that are unaware of the adaptive CoS system and would prefer to opt for model of pre-purchased throughput at a given SLA. It could be network policy that such routes that offer SLAs corresponding to the traditional DiffServ model retain these routes specifically for clients that request classic DiffServ. Alternatively, classic DiffServ can be perceived merely as further options for services to choose from in addition to the dynamic ones and opt for them if they so desire. Policies on filtering out specific QoS SLAs options to specific clients are left to the discretion of the operator.

The client may choose to define a local Forwarding Equivalence Class (FEC) that maps services onto QoS requirements and map the FEC onto the DSCP value that delivers this QoS requirement at that specific time of data transfer. Similar to the concept of FEC, the packets may not be of the same application or service or indeed have the same source/destination pair. Packets marked with the same DSCP value will be treated by the same way by the network. The client (or network interface entity), having decided what QoS is desired for a given service type at a specific time using this FEC-like mapping, marks the IP packets accordingly. This marking is then used by the network to route traffic as requested.

Unlike the conventional model of purchasing bandwidth in advance, the present method provides a more real-time ‘shop window’ style approach. Applications can now have time-variant QoS requirements and make use of the number of QoS SLA options offered. Clients can choose a different QoS SLA if a previously chosen SLA is no longer necessary. This might be the case when a client monitors end-to-end performance (e.g. arising from traffic traversing several network segments of which the present system offering dynamic CoS is one) and finds that they can opt for a lower CoS at a lower price if end-to-end performance is still satisfied across all the segments. The same applies to aggregates of traffic from a single large customer—different varieties of traffic are sent at different times of day and it might be more suitable to opt for a different CoS at different times, depending on the type of traffic being sent. Some applications might not be subject to stringent QoS SLAs but would require some QoS guarantee and can choose one of the available QoS options accordingly, trading off cost with performance in real-time and on a more granular basis. Pricing may be done in real-time based on usage rather than pre-determining what usage might look like and subsequently sending too much or too little traffic. This approach of demand management is similar to ordering groceries from a shop in real-time as the need arises, subject to current conditions, instead of periodically in advance and risking having too much left over or of running out.

The next task is to assign DSCP values to the generated prototypes. In this example, all 21 prototypes will be offered as individual DSCP values. Such values can indeed be generated sequentially or at random as long as they can be represented by the four available bits (or six if ECN is not used). Additional considerations for generating DSCP values are given below:
1) Reserve classic DiffServ DSCP values for clusters that offer the pre-defined QoS of classic DiffServ. This maintains backwards compatibility with clients that require an understanding of classic DiffServ and mark their IP packets with the pre-defined codepoints.
2) Generate DSCP values to reduce the possibility of errors, for example by generating values with maximum Hamming distance between them, that are within the acceptable range and do not correspond to classic DiffServ codepoints.
3) The generator of DSCP values can resist using values that are currently in use. This is useful if a mapping of current DSCP values to services is not done but the operator would like continuity in service flow across multiple iterations of the principal learning process. If a table of mapping between client source/destination, DSCP values, QoS features, route(s) and load distribution is maintained, then it might not be necessary to exclude values that are currently in use but instead update what the QoS features associated with those values mean in such a table.

Generating these DSCP values should be a routine matter for a person skilled in the art. The values may, for example, be generated by a software process which is executed by the network gateway. The DSCP values may be determined after the completion of the principal learning process. Once the DSCP values have been determined then the repository of available QoS models will be updated. This repository may be held by the network gateway. The DSCP value itself is only a concise lookup used by both client and the network to understand the more complex QoS features that a client desires and the network provides. Therefore, the look-up functionality can be performed by any other means, including explicit signalling in advance or any other QoS management protocol.

The second task to be performed following the completion of the principal learning process is to reserve resources for the QoS models on the respective pathways that have been determined to support them and associate these ‘tunnels’ with the DSCP values that have been generated in the preceding step for these QoS models.

This can be done with or without explicit reservation, MPLS with or without using DS-TE in the Maximum Allocation Model (MAM) or by using the Russian Doll Model (RDM). A single tunnel can be associated with a single DSCP value, multiple DSCP values can be mapped onto the same tunnel or indeed the same applies for sub-pools within a tunnel and their mapping to DSCP values. In the above example, a single tunnel is created for all dynamic QoS systems (tunnel bandwidth will be the sum of all bandwidths of the QoS models that are supported on that tunnel) and sub-pools were allocated, using MAM, to individual QoS models that are supported on the same route or link. We also associate one DSCP value to one QoS model. This means that one DSCP value can be mapped to multiple routes, each of which can be a sub-pool on a larger tunnel on a pathway (i.e. a collection of connected routers via links) that supports multiple QoS models. A single pathway will therefore only have one overall tunnel that encompasses all dynamic QoS routing, potentially leaving available bandwidth for other types of routing. Alternatively, separate tunnels can be established for every QoS model which means that a pathway can contain multiple tunnels. Each tunnel on a route is mapped to a single DSCP value with the possibility of multiple tunnels on many pathways being mapped to the same DSCP value. This denotes that multiple tunnels support the same QoS model which means that when a request arrives at the gateway with a DSCP value, the gateway has an option of more than one tunnel to which the incoming request can be assigned and/or distributed. Note that the gateway must then keep track of load distributions across multiple routes on the same QoS model as well as across different QoS models, which might be necessitated by the load balancer function described here. Note that this might result in a large number of tunnels on a single route and therefore the first approach of having a single tunnel per pathway and modifiable sub-pools within each tunnel to signify a QoS model (and therefore DSCP value) might be more suitable.

As discussed above, typical performance measures can be quantified in units of time or percentage. For example, jitter and delay are measured in milliseconds whereas loss and packet error ratio (PER) can be measured as a percentage of the total number of sent packets. These are single units that can be aggregated using one or more functions over a route to quantify the overall delay/jitter/loss/PER. Softer routing measures, however, do not naturally yield to this format. However, it is possible to represent most policy-related routing features in some quantifiable function, potentially on a per device basis, for example, the resilience of a single device can be defined to be its propensity to fail at a given time, the energy consumption of a single device can be measured and is related to factors such as traffic, and the cost of transmission per bit on a device is related to the use of its resources by traffic traversing the device. The same can be said of links connecting devices as well.

In order to enrich QoS models with other than performance related features we specify how we can represent “softer” features like reliability, energy or cost and how we can combine them with performance related QoS models. The performance related QoS model Pᵢ ca be transformed into an extended QoS model

\tilde{P}ᵢ= [symbol] pᵢ,cᵢ,Sᵢ [symbol] [4]

where S represents a collection of “soft” or non-performance related features like resilience, energy and cost. Other non-performance related features are possible and depend only on operator preference. Geography could be another possible feature, indicating that traffic is only routed across certain countries, for example.

Therefore, a function can be defined that represents, either as a model or by measurement, a basic metric per device. We also define a method of aggregating this basic metric over a number of devices and links to obtain the overall route performance as a metric with respect to that policy model. Note that this metric can be defined at any level of granularity. It can be defined per interface, in which case one also needs a method of translation from interface to device when appropriate. For example, if energy consumption is defined per interface, it might be necessary to work out the energy consumption of the device by aggregating over the total number of interfaces. This aggregation may not be a linear process. For example, a device with multiple interfaces has a base idle energy consumption in addition to consumption due to traffic which means that switching on the first interface results in a higher spike in energy usage compared to turning on subsequent interfaces on the same device. Alternatively, the route can be defined to comprise of a number of linkages between interfaces and therefore the device-level aggregation is not necessary.

The basic metric comprises of two parts, one of which is static and the other is dynamic. The dynamic component may be obtained by measurement. The static component covers the scenario where the dynamic component has not yet been measured. For example, the static component of a resilience metric can be derived from the vendor-advertised Mean Time between Failures (MTBF) whereas the dynamic component can be the likelihood of failure observed from network events for that device. In this scenario, even if no failures have been observed on that device, as might be the case at start-up, the vendor-specified MTBF can still be used to determine the likelihood of failure and the value of the resilience metric can be varied as more information becomes available over time. The dynamic component may depend on multiple variables including time. For example, the monetary cost of data transmission per interface can depend on the popularity of the routes that traverse the interface at the present time, the energy usage of that interface as well as a static component relating to standard infrastructure maintenance. Another example is that the energy usage of a device can depend on the traffic handled by the device which is time-variant.

Some of these routing models may be related to each other. For example, the cost model can be related to energy consumption at the time and therefore energy usage will influence the device's cost in the cost model as well as form its own energy-related model. It will be understood that the dynamic component adds more information to the static component and its value can be dependent on a number of conditions at the time of evaluation. The dynamic component can either be modelled mathematically, if possible, or observed under a number of conditions and learned over time using a learning method.

The combination of the static and dynamic component forms the basic metric per device. The next step is the aggregation of this metric over the route itself. This can also be defined as a function of the basic metric. For example, the likelihood for a route to fail is the likelihood of its weakest component to fail. The energy usage of a route is the summation of the energy usage of each of the individual components that form that route. Similarly, the cost of a route is the summation of the cost of each of its components. Using such a function, it is possible to aggregate from a device level to a route level. Note that there can be policies can be defined directly at the route level. One example of this is monetary cost—traffic that belongs to a single CoS can be priced in its entirety on a per unit bandwidth basis rather than built up from a device. In the following discussion, it is only important to have a route level description of a metric. Some examples of how this metric can be derived are given but are not comprehensive and do not preclude any other method of generating this value.

Routes that carry traffic are characterised according to the performance experienced by the traffic flows into dynamic QoS ‘bins’ using clustering. This process is also used to classify the various routes into a granular performance-like model for the softer policy. The goal is to achieve a table like that shown in Table 4 below:

TABLE 4
Sample feature table that classifies routes
into performance bins within the feature

| Feature Values (e.g. | Routes that exhibit the |
|---|---|
| Resilience, Energy usage, Cost) | specified band of behaviour |
| A1 | A\|c = c1, B\|c = c2, C\|c = c3 |
| A2 | A\|c = c2, D\|c = c4, E\|c = c1, F\|c = c5 |
| A3 | C\|c = c6, G\|c = c3 |

The feature values specify the band of behaviour within the feature and the routes on the right (A-G) are classified within these bands. Routes can also contain a conformance variable to the bin itself, which is related to the distance of the route from its cluster centre Ax. For example, A1 can be a resilience metric of 80% over a pre-defined time period and c1 is the value that represents the distance of route A to this cluster centre of A1. The distance of the specific route to its cluster centre is the variable c, i.e. a measure of conformance of the route to the QoS model. This value in this instance can be ±5%, which means the route A deviates from cluster centre A1 by 5% and therefore has a resilience metric between 75-85%. Note that it might be necessary to aggregate from the cluster centres discovered using the clustering algorithm into larger bands, as desired, to reduce granularity. For example, cost can be represented in intervals, i.e. in the range £A1 to £B1, rather than as a ‘cloud’ of confidence around cluster centre £A1.

The actions performed in the network are the same as those discussed above. In one possible implementation, the operator chooses to establish MPLS tunnels on a dynamic basis, taking into account the cost (processing, signalling, time and monetary) of establishing such tunnels as a measure of resistance to make such changes, with DSCP values associated with tunnels that support the soft DiffServ model (methods of generating the DSCP values are described above). A repository of route profiles against the DSCP values is stored, which can be accessed by the client. The method described above is to be extended to include such softer routing models as well as the performance metric-optimised model. The scoreboard can take the form of a client-accessible repository stored in the network gateway or alternatively in some other entity such as an admission controller, bandwidth broker or similar. Alternatively, clients can learn of the available dynamic CoS models including the softer policy-driven models using a signalling protocol such as NSIS at admission stage. There are, therefore, a number of different methods that can be used to communicate a given set of available time-variant QoS models to a set of clients.

Different DSCP values can be associated with different ‘bins’ of categorisation within each soft routing model. For example, a DSCP value X can be assigned to routes that have an energy usage of A-B mW whereas a different DSCP value Y can be assigned to routes that have an energy usage of C-D mW where D>C>B>A. The repository holds the mapping between routes that support X and routes that support Y. Alternatively, a single DSCP value can be assigned to an entire soft routing model which implies that the network will choose one or more routes from the available set of routes to the destination in a manner than suits the network operator. For example, the operator can decide to always offer the best performing route within a given model on a first-come-first-served manner or alternatively offer the route that performs better than the minimum agreed threshold and work upwards towards filling better performing routes with increasing traffic. Another option is for the operator to assign traffic to routes with decreasing available bandwidth. There are many choices in route allocation to a given service that can be implemented.

The Label Edge Router (LER) Forwarding Information Base (FIB) is updated with the FEC-to-tunnel mapping, where there can be a many-to-many relationship between the FECs and DSCP values. One FEC can be routed through one or more tunnels with the possibility of load balancing across them. In the same way, one tunnel can support a number of FECs, either using sub-pools (DS-TE) and/or scheduling profiles in the individual LSRs. The operator can also choose to operate the network only on scheduling and traffic profiling without reservations on links.

Resilience

It can be argued that a break in connectivity, for example the failure of an interface, results in performance degradation and therefore does not need to be quantified I separately. However, it is possible that a route performs very well when it is available but has a high propensity to fail and that route degradation is experienced only at these times of failure rather than low levels of degradation over a longer period of time. When failure does happen the time taken to re-organise the route, for example switch to a backup link, will determine whether or not degradation occurs. On the other hand, degradation can occur even without the failure of network elements and this can be unacceptable to certain types of traffic. Clients may be willing to take the risk of a failure if the performance otherwise is acceptable with the knowledge that such failure is unlikely to happen. Therefore, it is possible that failure does not necessarily lead to degradation and also that it happens infrequently enough to cause sudden bursts of degradation which recovers once the path is re-established rather than continuous detriment. Traffic that is resilient to prolonged detriment can choose routes of low performance but have high resilience or alternatively routes that are sensitive to even slight variation in performance can opt for routes that exhibit high resilience as well as high performance. Evidently, a route that exhibits low resilience is also likely to have poor performance because the failures happen often enough to affect the performance features of the route itself rather than being sudden and infrequent.

The resilience of a route is the probability of the route not failing during data transmission. Failure can mean that the transmission fails or has to be re-routed. While re-routing is usually done fully automatically and may not be noticeable for clients transmitting or receiving data across a network, it is still possible that re-routing results in temporary packet loss and therefore a loss in QoS. The operator can choose to express resilience in different ways. For example, resilience can mean that the data will be transmitted across a specific route without failure. It could also mean that the data will arrive at the destination without experiencing noticeable failure, that is re-routing to recover from route failure would not count towards the resilience measure. Resilience will not include any QoS related features because these are already dealt with by the QoS model chosen for the transmission. Resilience will only mean the likelihood of the transmission to arrive completely and without interruption at the destination under observation of whatever QoS was agreed. Degradation in QoS will be attributed to the QoS model and not the resilience feature. Arriving “completely” shall exclude any packet error or packet loss rate that is dealt with by the QoS model and “without interruption” shall exclude phenomena like jitter that are also dealt with by the QoS model. Resilience will cover only the probability that elements on the route are failing and the subsequent result of the transmission failing.

Elements in a route can fail for different reasons. A router may fail due to hardware issues or due to software faults which forces it to reboot. The probabilities for these events are different and can be considered independently. However, for reasons of simplicity failure will only be considered from a statistical point of view and there is no differentiation between failure modes. Resilience models can be arbitrarily sophisticated and consider a number of special cases and a multitude of failure reasons. The network operator will decide how much effort should be spent building resilience models. The nature of a resilience model does not change by adding more detail, but it may become more accurate.

In order for a route to fail, a failure of a single element on the route is sufficient. While a failure of one element in a network can trigger the failure of other elements, we assume that the initial failure of an element is independent of the state other non-failing elements. We consider the probability that an element fails randomly without external influences. We can choose to consider the failure of an element based on the previous failure of other elements and this information can be used to update the resilience rating of a route temporarily and in real time. We can also choose to consider pre-configured backup pathways. If a router has a backup interface that can be used if the primary interface fails or if a second router or link is kept idle to take over if the primary router/link fails, then this reduces the probability that the route will fail at this point. The availability A of a system is used as a representation of resilience. Availability is calculated as follows:

$$A = \frac{MTBF}{MTBF + MTTR} \qquad [ 5 ]$$

where MTBF is the mean time between failures and MTTR is the mean time to repair, that is the time to reboot a router or replace failed hardware. Availability is expressed in percent and is often measured in “number of nines”. An availability of 99.9999% (6 nines) means a system is not available for about 30 seconds per year.

Consider a route from source S to destination D with four routers X1-X4 and four outgoing links L1-L4. Without having any information about historic failures we can use the mean time between failures information provided by vendors. Assume we have the following values for the availability of the routers and links.

TABLE 5
Availability parameters for network elements

| Element | X1 | X2 | X3 | X4 | L1 | L2 | L3 | L4 |
|---|---|---|---|---|---|---|---|---|
| Availability | 99.999 | 99.999 | 99.9999 | 99.9999 | 99.99 | 99.99 | 99.99 | 99.99 |

The route is sequential and has no configured backup paths. Therefore the availability of the route becomes the product over all availabilities of the route components, i.e.

$$\begin{matrix}A = 99.999 \% \times 99.999 \% \times 99.9999 \% \times 99.9999 \% \times 99.99 \% \times 99.99 \% \times \\ 99.99 \% \times 99.99 \% \\ = 99.95781 \%\end{matrix}$$

Now consider a variation of the route where X2 and X4 have identical backup elements and outgoing backup links. The availability of a redundant system is

A=1−(1−A′)² [6]

where A′ is the availability of the redundant systems. The combined availability of router X2 and its outgoing link L2 is 99.999%×99.99%=99.989. The availability of a redundant system comprising of two identical X2 routers and L2 links is thus

A=1−(1−0.99989)²=0.99999758 or 99.999758%.

For a redundant system comprising of two X4/L4 combinations we obtain A=99.99999898%. Now we can compute the availability of the complete route by multiplying together the values for the two redundant subsystems X2/L2 and X4/L4 with the remaining routers and links and we obtain the overall availability of A=99.978783%. Thus, the route without backup paths will be unavailable for 221 minutes per year, while the route with backup paths will only be unavailable for 112 minutes.

Reliability can also be expressed by other means than availability. For example, the network operator could maintain a survival function for each network element and use this to obtain estimates for the probability that an element will fail before a particular time.

The resilience [symbol] of an element is comprised of a static resilience [symbol] provided by, for example, the manufacturer and a dynamic resilience [symbol] which can be estimated based on observing an element in service and its behaviour under load. While the base resilience will typically cover hardware failures, the dynamic resilience covers software failures and crashes due to unusual traffic situations or bugs in the operating system of an element. The dynamic reliability can take the behaviour of the network in different time periods or under different load profiles into account. For example, resilience during night hours may be different from availability during day hours because of different traffic conditions. The dynamic resilience can be continuously improved through a learning process by regularly updating it with historic observations about the behaviours of network elements. The dynamic resilience function can take a variety of factors into account, like time, traffic, number of elements being down, etc.

For example, using availability to represent resilience and by monitoring a particular type of router we may find that the availability during the day is 99.9% and during night it is 99.99%. Assume we also have the information from the manufacturer that A=99.999% for this type of router in terms of hardware failures. That means we define

$${R}_{d} ( t ) = {A}_{d} ( t ) = \{ \begin{matrix}99.9 \% for t ∈ [ 06 \text{:} 00 , 22 \text{:} 00 ] \\ 99.99 \% for t ∈ [ 22 \text{:} 00 , 06 \text{:} 00 ]\end{matrix} \\ and \\ R ( t ) = {R}_{s} \cdot {R}_{d} ( t ) = A \cdot {A}_{d} ( t ) = \{ \begin{matrix}99.89 \% for t ∈ [ 06 \text{:} 00 , 22 \text{:} 00 ] \\ 99.989 \% for t ∈ [ 22 \text{:} 00 , 06 \text{:} 00 ]\end{matrix}$$

We obtain the overall availability by multiplying the static and dynamic availability. The aggregation function for the resilience function based on availability is the product, i.e. to compute the resilience of a route we multiply the availabilities of all elements on this route. Backup paths can be taken into account as described above with respect to availability.

We now iterate over all available routes and determine their resilience value as described above. The next step is to aggregate routes into bands of resilience. This is done by one-dimensional cluster analysis on the resilience values or alternatively using intervals and their mid-points defined by the operator. Each route is assigned to the closest mid-point/cluster centre and the deviation from the cluster centre is the confidence value c described above.

Energy Consumption

The energy consumption of a route can be computed by adding up the energy consumption of all the elements on that particular route. The static energy function of an element is the energy is consumes while being idle, i.e. just being switched on without routing any traffic. The dynamic energy function is the traffic dependent energy used whilst being active and routing traffic. Both functions can be provided by the manufacturer or they may be being measured over time while the element is switched on. Ways of quantifying the dynamic energy function are, for example, measuring CPU utilisation or throughput on a network element.

Assume for a particular type of router it is known that it uses 1800W when idle and the additional energy use under load in dependency from throughput C in Gb/s is

E_{d}(C)=C·15W [7]

For the overall energy function of this router we obtain

E(C)=Eₛ+E_{d}(C)=1800W+C·15W [8]

E_{d}(C) can also be a tabulated function provided by the manufacturer of the device if the energy increment is a non-linear function of traffic over the device. For the overall energy consumption of a route we simply add up all energy functions of the elements on that route, i.e. the aggregation function for energy consumption is summation. Note also that energy consumption figures need not be represented per traffic unit but instead per user or any other method of aggregation.

If a network element, such as a router, is part of several routes its energy consumption can be distributed across the routes. This can be done equally or weighted by route capacity, for example. Alternatively, the energy consumption can be calculated on a per interface basis and if an interface supports multiple routes or tunnels the energy consumption can be subdivided further. However, for reasons of simplicity the energy consumption can also be wholly attributed to all routes supported by an element since the absolute value is not important for the selection of routes, only the relative values matter. The tabulation of energy consumption bands against routes is done as described above in respect of resilience.

Cost

The cost of operating a route is an additive measure, similar to the method used when determining energy consumption. There is a static cost Cₛ for operating an element and a dynamic traffic dependent element C_{d} which can also depend on a variety of other factors like time, number of active clients, congestion, energy consumption, resilience, etc. It can also depend on the actual QoS offered as well as the adherence of the route to the QoS features themselves, i.e. the distance of the route from the cluster centre in the performance model. Better bands of performance within a single QoS feature can be priced higher than lower bands of performance. Different QoS features can be priced differently. Therefore, each QoS model can have a dynamic price based on the band of operation it offers within a QoS feature as well as the QoS feature itself. Additionally, the route chosen within the QoS model can also have an impact on C_{d}. Routes perform to different extents of deviation from the cluster centre and the distance of a route from the cluster centre can be incorporated into the dynamic pricing function as well. Therefore, each traffic flow can potentially be priced individually, depending on the QoS model it consumes, the route(s) it takes through the network within that QoS model as well as other network-related features such as existing congestion etc. (see preceding discussion). The cost function can be used by the network operator to influence the uptake of certain routes, the distribution of traffic and control revenue. Note that the tabulation of energy consumption bands against routes is performed as described in the worked example for resilience.

There are different types of cluster analysis that can be used to learn model prototypes. We use a centroid-based clustering method like k-means clustering or variations thereof such as fuzzy c-means clustering (F Hoppner, et al “Fuzzy Clustering”, Wiley, 1999). Centroid based clustering uses a fixed number of cluster centres or prototypes and determines the distance of each data vector from a training database to each prototype. The distances are then used to update each prototype vector and move it close to the centre of the group of data vectors it represents. Different types of clustering algorithms use different distance measures and different ways of assigning a data vector to a prototype. K-means uses Euclidean distance and assigns each data vector to its closest prototype. Fuzzy c-means assigns each data vector to all prototype vectors to a degree such that the membership degrees add up to 1.

It will be understood that the method of the present invention may be implemented by executing computer code on a general purpose computing apparatus. It should be understood that the structure of the general purpose computing apparatus is not critical as long as it is capable of executing the computer code which performs a method according to the present invention. Such computer code may be deployed to such a general purpose computing apparatus via download, for example via the internet, or on some physical media, for example, DVD, CD-ROM, USB memory stick, etc.

In one aspect, the present invention provides a method of operating a communications network such that routing models for the network can be constructed on the basis of parameters which are not directly related to the transmission performance of the network. Indirectly related parameters, such as resilience, cost or energy use, may be used to construct the routing models such that a request for a communication session may be based on a required indirect parameter value.

1. A method of operating a communications network, the method comprising the steps of:
defining a plurality of parameter value bins for one or more parameters which are indirectly linked to the performance of the network,
for each of a plurality of routes through a communications network;
determining an average value for the one or more indirect parameters for the route and assigning the route to one of the plurality of parameter value bins; and
determining a measure of the variance of the indirect parameter from the centre of the assigned parameter value bin;
receiving a request for a communications session through the communications network, the request comprising a request for the session to be assigned to a route assigned to one or more of the plurality of parameter value bins; and
accepting the request for the communications session if such a request can be satisfied.

2. A method according to claim 1, wherein the assignment of each of the plurality of network routes to one of the plurality of parameter value bins comprises a cluster analysis of the plurality of indirect parameter values.

3. A method according to claim 1, wherein the method comprises the further steps of:
determining a plurality of performance models, each of the performance models comprising a first vector representing the average value of one or more transmission parameters and a second vector representing a confidence interval for the one or more transmission parameters;
for each entry in a training dataset, assigning one of the plurality of performance models that entry, the training dataset comprising data relating to a plurality of data transmissions that were carried by the communications network in a predetermined time period;
for each one of a plurality of routes through the communications network, assigning one or more of the plurality of performance models to that route; and
accepting a request for a communication session using the communications network in accordance with the one or more performance models assigned to one or more of the plurality of routes through the communications network.

4. A method according to claim 1, wherein the parameters which are indirectly linked to the performance of the network may comprise one or more of resilience, cost or energy consumption.

5. A data carrier device comprising computer executable code for performing a method according to a of claim 1.

6. An apparatus configured to, in use, perform a method according to claim 1.

7. A communications network comprising a plurality of nodes, a plurality of communications links inter-connecting the plurality of nodes, and a network gateway, the communications network being configured to, in use, perform a method according to claim 1.
